(19) United States
(12) Patent Application Publication
(10) Pub. No.: US 2026/0107128 A1
(43) Pub. Date: Apr. 16, 2026

(54) UE Profiles and Dynamic UE Capability Change

(71) Applicant: Apple Inc., Cupertino, CA (US)

(72) Inventors: Christian Hofmann, Muenchen (DE); Panagiotis Botsinis, Munich (DE); Sameh M. Eldessoki, Munich (DE); Amr Abdelrahman Yousef A. Mostafa, Munich (DE); Tarik Tabet, Carlsbad, CA (US); Alperen Gundogan, Munich (DE)

(21) Appl. No.: 18/913,793

(22) Filed: Oct. 11, 2024

(51) Int. Cl. H04W 8/20; H04W 8/22; H04W 24/02; H04W 36/38

(52) U.S. Cl. CPC H04W 8/20; H04W 8/22; H04W 24/02; H04W 36/385

(57) ABSTRACT

An apparatus of a user equipment (UE) comprises one or more processors coupled to a memory and configured to generate, at the UE, a UE profile message for transmission to a network (NW) via a base station. The UE profile message indicates support of one or more select UE profiles from a list of pre-determined UE profiles, and indicates which of the one or more select UE profiles is an active UE profile at the UE. Each UE profile comprises a pre-determined subset of individual UE capability features grouped together to define a UE role in the NW. The processors are configured to receive, at the UE, a UE profile confirmation message from the NW via the base station indicating UE profiles supported by the NW and acknowledging active UE profiles.

### FIELD

Embodiments of the invention relate to wireless communications, including apparatuses, systems, and methods for user equipment (UE) profiles and dynamic UE capability change in a cellular communications network.

### DESCRIPTION OF THE RELATED ART

Wireless communication systems are used to provide various communication services such as telephone, video, data and messaging. The wireless communication systems can support communication with multiple users by sharing available system resources such as bandwidth and transmit power.

The wireless communication system may include a number of base stations (BSs) that can support communication for a number of user equipment (UEs). A BS may be referred to as a Node B, a gNB, an access point (AP), a radio head, a transmit receive point (TRP), a New Radio (NR) BS, a 5G Node B, or the like. A UE may be referred to as a wireless mobile device or cellular phone.

Telecommunication standards have been adopted to provide a common protocol to enable different UEs and BSs to communicate on a municipal, national, regional, and even global level. Wireless communication system standards and protocols can include the 3rd Generation Partnership Project (3GPP) long term evolution (LTE) (e.g., 4G) or new radio (NR) (e.g., 5G). In 3GPP radio access networks (RANs) in LTE systems, the base station can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with the UE. In fifth generation (5G) wireless RANs, RAN Nodes can include a 5G Node, or NR node (also referred to as a next generation Node B or g Node B (gNB)).

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6 illustrates an example of a baseband processor architecture for a UE, according to some embodiments.

FIG. 7 illustrates an example block diagram of an interface of baseband circuitry according to some embodiments.

FIG. 8 illustrates example components of a core network in accordance with some embodiments.

FIG. 9 illustrates a diagram of an example UE configuration out of a capability set, according to some embodiments.

FIG. 10 illustrates a diagram of example UE profiles, according to some embodiments.

FIG. 11. illustrates a diagram of example active profile change on a UE, according to some embodiments.

FIG. 12 illustrates a diagram of example UE profiles and parameters, according to some embodiments.

FIG. 13 illustrates a diagram of example UE profiles with semi-static and dynamic parameters, according to some embodiments.

FIG. 14 illustrates an example signaling of UE profiles between a UE and a base station, according to some embodiments.

FIG. 15 illustrates a flow chart of an example of a method for signaling UE capabilities and profiles, according to some embodiments.

FIG. 16 illustrates an example signaling of UE profiles between a source base station and a target base station, according to some embodiments.

FIG. 17 illustrates an example signaling of UE profiles between a UE and a base station, according to some embodiments.

FIG. 18 illustrates an example signaling of implicit UE profile changes between a UE and a base station, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. 5G NR can support scalable channel bandwidths from 5 MHz to 100 MHz in Frequency Range 1 (FR1) and up to 400 MHz in FR2. In other radio access technologies, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to”may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

The example embodiments may be further understood with reference to the following description and the related appended drawings, wherein like elements are provided with the same reference numerals. The example embodiments relate to UE profiles, as a pre-determined subset of UE capabilities grouped together to define a UE role in the network, and dynamic UE capability change.

The example embodiments are described with regard to communication between a user equipment (UE) and a network (NW) via a base station, such as a next generation Node B (gNB). However, reference to a UE or a base station is merely provided for illustrative purposes. The example embodiments may be utilized with any electronic component that may establish a connection to a network and is configured with the hardware, software, and/or firmware to support UE profiles and dynamic configuration. Therefore, the base station or UE as described herein is used to represent any appropriate type of electronic component.

The example embodiments are also described with regard to a fifth generation (5G) or sixth generation (6G) New Radio (NR) network that may configure a UE with a UE profile as a narrowed down subset of UE capabilities. However, reference to a 5G or 6G NR network is merely provided for illustrative purposes. The example embodiments may be utilized with any appropriate type of network.

Throughout this description various information elements (IEs) are referred to by specific names. It should be understood that these names are only examples and the IEs carrying the information referred to throughout this description may be referred to by other names by various entities.

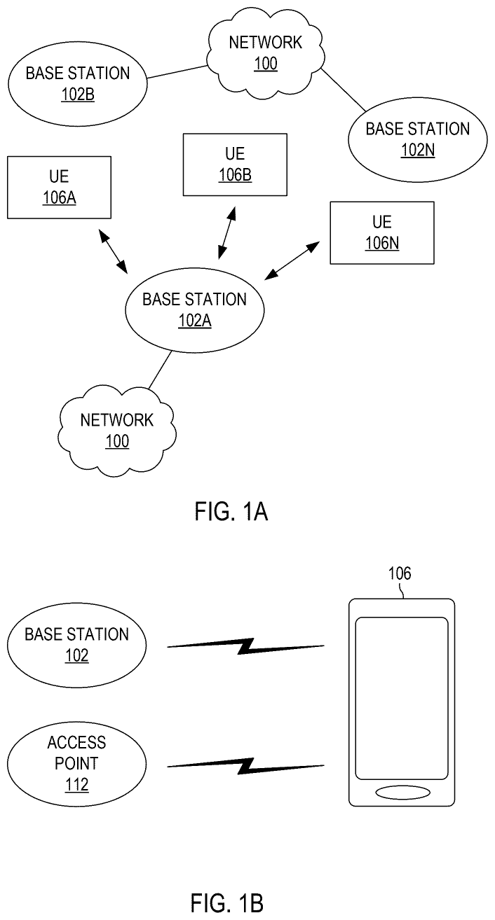

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, also referred to as the Evolved Universal Terrestrial Radio Access Network (E-UTRAN, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1A, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1A might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/eHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTT or LTE or GSM), and separate radios for communicating using each of Wi-Fi and Bluetooth. Other configurations are also possible.

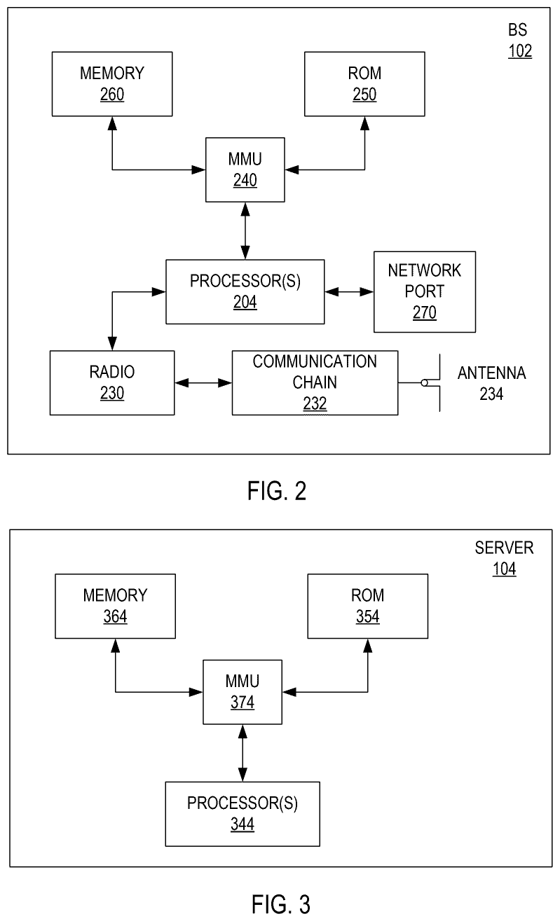

### FIG. 2: Block Diagram of a Base Station

FIG. 2 illustrates an example block diagram of a base station 102, according to some embodiments. It is noted that the base station of FIG. 2 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

In some embodiments, the base station or gNB 102, and/or processors 204 thereof, can be capable of and configured to receive and decode transmission from a user equipment (UE): UE profile information messages, UE profile default configuration requests, UE profile change criteria confirmation messages, and UE profile change criteria indications; and generate and transmit (or encode for transmission): UE profile confirmation messages, UE profile default configuration profiles, radio resource control (RRC) reconfigurations, handover (HO) requests, HO commands, UE profile change criteria requests and UE profile change criteria responses. In addition, the base station or gNB 102, and/or processors 204 thereof, can be capable of and configured to store or negotiate pre-determined UE profiles.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, and UE devices 106 access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

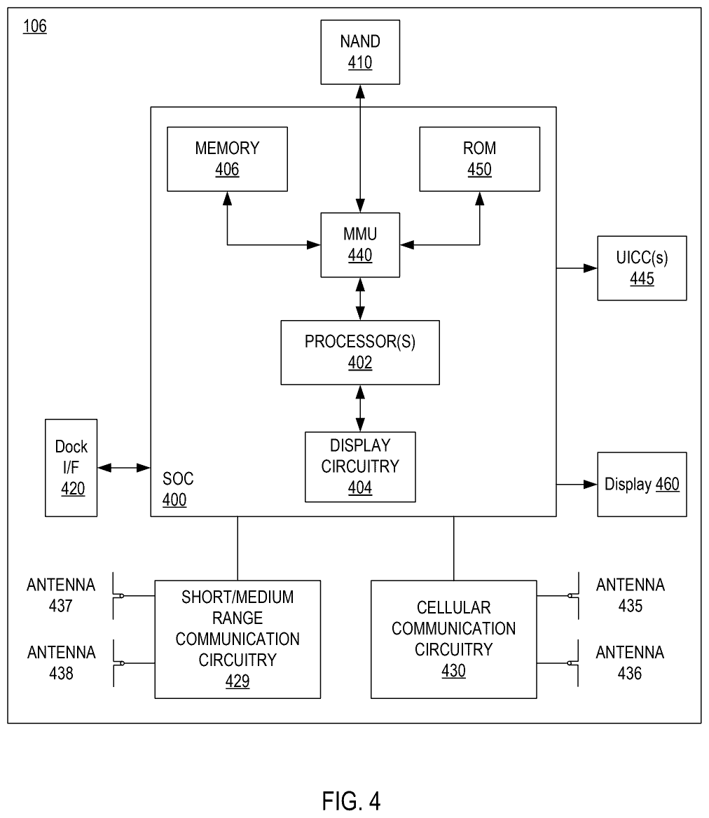

### FIG. 4: Block Diagram of a User Equipment

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMs 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VoLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

In some embodiments, the UE 106 and/or the processors 402 thereof can be configured to and/or capable of determining or initiating a UE profile transfer, determine or initiate a UE profile change, and trigger a UE profile change criteria indication. In addition, the UE 106 and/or the processors 402 thereof can be configured to and/or capable of storing or negotiation pre-determined UE profiles.

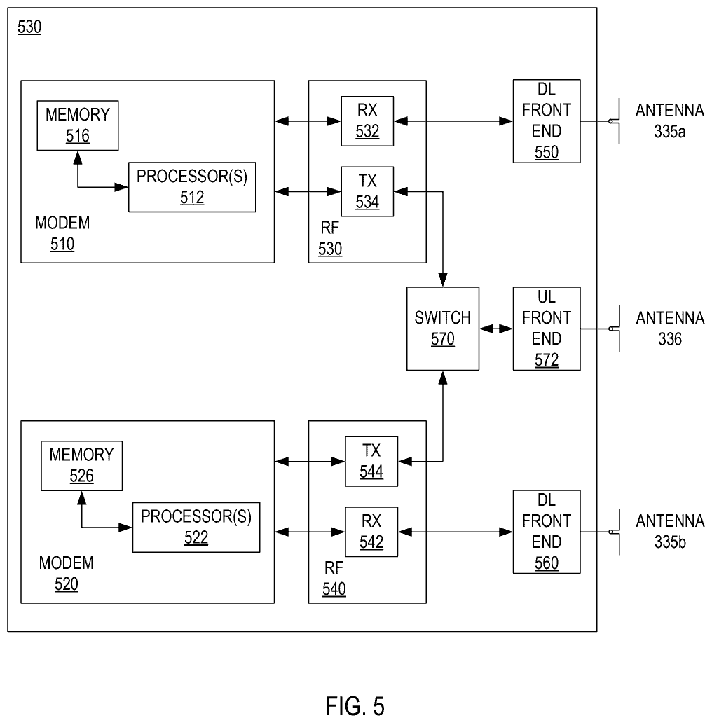

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335a, 335b, and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335a, 335b, and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

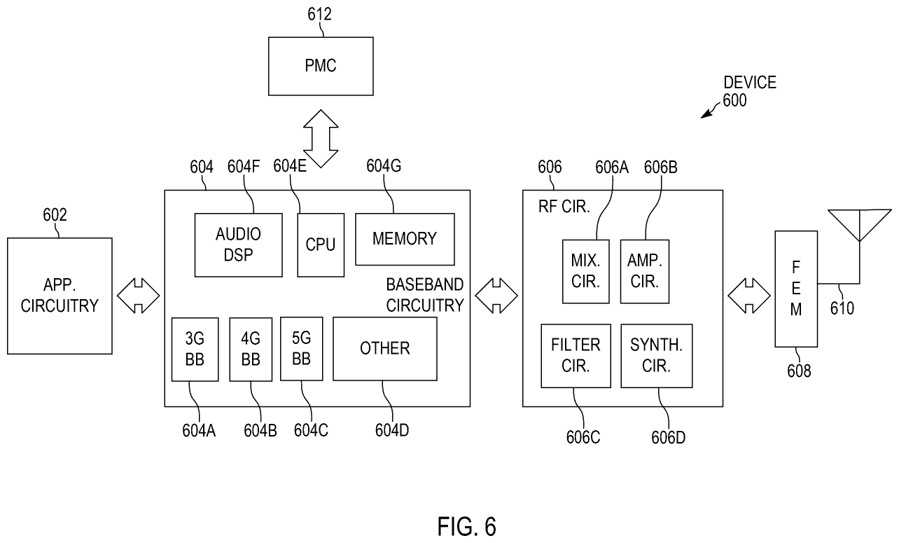

### FIG. 6: Block Diagram of a Baseband Processor Architecture for a UE

FIG. 6 illustrates example components of a device 600 in accordance with some embodiments. It is noted that the device of FIG. 6 is merely one example of a possible system, and that features of this disclosure may be implemented in any of various UEs, as desired.

In some embodiments, the device 600 may include application circuitry 602, baseband circuitry 604, Radio Frequency (RF) circuitry 606, front-end module (FEM) circuitry 608, one or more antennas 610, and power management circuitry (PMC) 612 coupled together at least as shown. The components of the illustrated device 600 may be included in a UE 106 or a RAN node. In some embodiments, the device 600 may include less elements (e.g., a RAN node may not utilize application circuitry 602, and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 606 and to generate baseband signals for a transmit signal path of the RF circuitry 606. Baseband processing circuity 604 may interface with the application circuitry 602 for generation and processing of the baseband signals and for controlling operations of the RF circuitry 606. For example, in some embodiments, the baseband circuitry 604 may include a third generation (3G) baseband processor 604A, a fourth generation (4G) baseband processor 604B, a fifth generation (5G) baseband processor 604C, or other baseband processor(s) 604D for other existing generations, generations in development or to be developed in the future (e.g., second generation (2G), sixth generation (6G), etc.). The baseband circuitry 604 (e.g., one or more of baseband processors 604A-D) may handle various radio control functions that enable communication with one or more radio networks via the RF circuitry 606. In other embodiments, some or all of the functionality of baseband processors 604A-D may be included in modules stored in the memory 604G and executed via a Central Processing Unit (CPU) 604E. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include one or more audio digital signal processor(s) (DSP) 604F. The audio DSP(s) 604F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some embodiments, the receive signal path of the RF circuitry 606 may include mixer circuitry 606a, amplifier circuitry 606b and filter circuitry 606c. In some embodiments, the transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a necessity. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c.

In some embodiments, the mixer circuitry 606a of the receive signal path and the mixer circuitry 606a of the transmit signal path may include two or more mixers and may be arranged for quadrature downconversion and upconversion, respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a may be arranged for direct downconversion and direct upconversion, respectively. In some embodiments, the mixer circuitry 606a of the receive signal path and the mixer circuitry 606a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect.

In some embodiments, the synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a necessity. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 606 may include an IQ/polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610. In various embodiments, the amplification through the transmit or receive signal paths may be done solely in the RF circuitry 606, solely in the FEM 608, or in both the RF circuitry 606 and the FEM 608.

In some embodiments, the FEM circuitry 608 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610).

In some embodiments, the PMC 612 may manage power provided to the baseband circuitry 604. In particular, the PMC 612 may control power-source selection, voltage scaling, battery charging, or DC-to-DC conversion. The PMC 612 may often be included when the device 600 is capable of being powered by a battery, for example, when the device is included in a UE. The PMC 612 may increase the power conversion efficiency while providing desirable implementation size and heat dissipation characteristics.

While FIG. 6 shows the PMC 612 coupled only with the baseband circuitry 604, in other embodiments the PMC 612 may be additionally or alternatively coupled with, and perform similar power management operations for, other components such as, but not limited to, application circuitry 602, RF circuitry 606, or FEM 608.

In some embodiments, the PMC 612 may control, or otherwise be part of, various power saving mechanisms of the device 600. For example, if the device 600 is in a radio resource control_Connected (RRC_Connected) state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC_Idle state, where it disconnects from the network and does not perform operations such as channel quality feedback, handover, etc. The device 600 goes into a very low power state and it performs paging where again it periodically wakes up to listen to the network and then powers down again. The device 600 may not receive data in this state, in order to receive data, it will transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 602 and processors of the baseband circuitry 604 may be used to execute elements of one or more instances of a protocol stack. For example, processors of the baseband circuitry 604, alone or in combination, may be used execute Layer 3, Layer 2, or Layer 1 functionality, while processors of the application circuitry 604 may utilize data (e.g., packet data) received from these layers and further execute Layer 4 functionality (e.g., transmission communication protocol (TCP) and user datagram protocol (UDP) layers). As referred to herein, Layer 3 (L3) may comprise a radio resource control (RRC) layer, described in further detail below. As referred to herein, Layer 2 (L2) may comprise a medium access control (MAC) layer, a radio link control (RLC) layer, and a packet data convergence protocol (PDCP) layer, described in further detail below. As referred to herein, Layer 1 (L1) may comprise a physical (PHY) layer of a UE/RAN node, described in further detail below. Accordingly, the baseband circuitry 604 can be used to encode a message for transmission between a UE and a gNB, or decode a message received between a UE and a gNB.

For example, the baseband circuitry 604 can be configured to generate or encode for transmission to the NW 100 via the base station or gNB 102: a UE profile information message, a UE profile default configuration request message, UE profile change messages, UE profile change criteria indications and UE profile change criteria confirmations; and receive or decode from the NW 100 via the base station or gNB 102: a UE profile confirmation message, UE profile default configuration profiles, RRC reconfiguration messages, HO commands, UE profile change criteria requests and UE profile change criteria responses. These examples are not intended to be limiting. The baseband circuitry can be used as previously described.

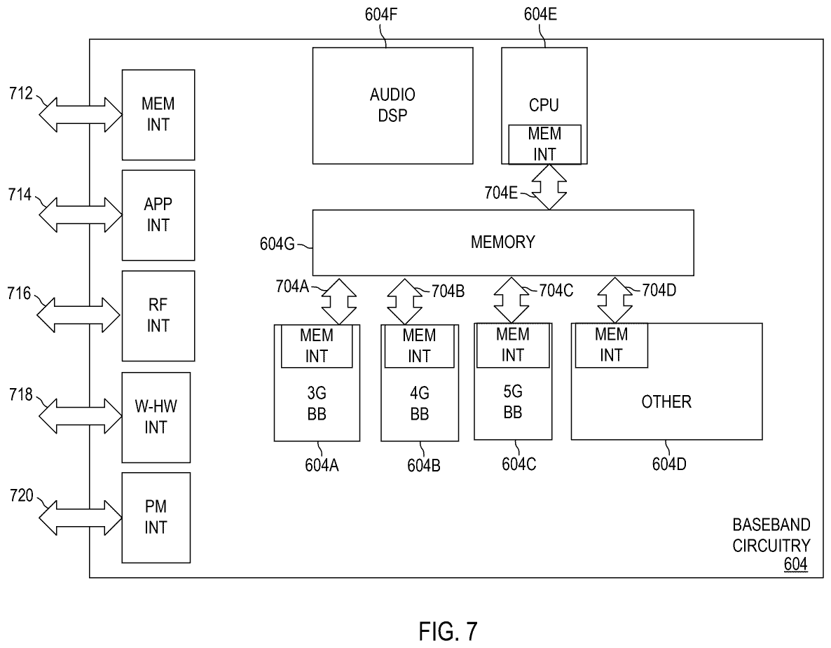

### FIG. 7: Block Diagram of an Interface of Baseband Circuitry

FIG. 7 illustrates example interfaces of baseband circuitry in accordance with some embodiments. It is noted that the baseband circuitry of FIG. 7 is merely one example of a possible circuitry, and that features of this disclosure may be implemented in any of various systems, as desired.

As discussed above, the baseband circuitry 604 of FIG. 6 may comprise processors 604A-604E and a memory 604G utilized by said processors. Each of the processors 604A-604E may include a memory interface, 704A-704E, respectively, to send/receive data to/from the memory 604G.

The baseband circuitry 604 may further include one or more interfaces to communicatively couple to other circuitries/devices, such as a memory interface 712 (e.g., an interface to send/receive data to/from memory external to the baseband circuitry 604), an application circuitry interface 714 (e.g., an interface to send/receive data to/from the application circuitry 602 of FIG. 6), an RF circuitry interface 716 (e.g., an interface to send/receive data to/from RF circuitry 606 of FIG. 6), a wireless hardware connectivity interface 718 (e.g., an interface to send/receive data to/from Near Field Communication (NFC) components, Bluetooth® components (e.g., Bluetooth® Low Energy), Wi-Fi® components, and other communication components), and a power management interface 720 (e.g., an interface to send/receive power or control signals to/from the PMC 612.

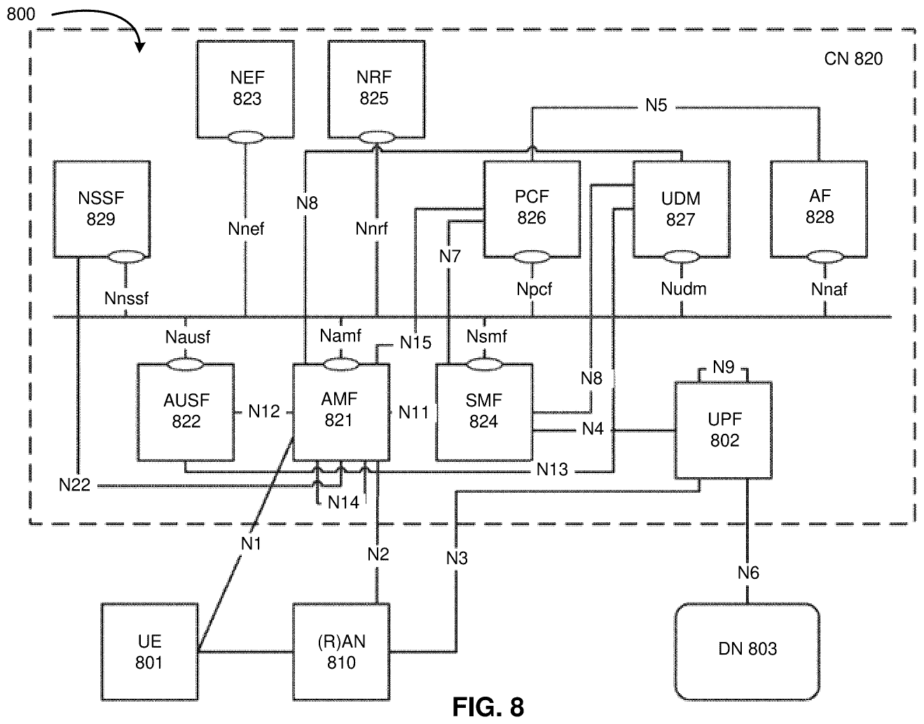

### FIG. 8: Core Network

FIG. 8 illustrates an example architecture of a system 800 including a core network (CN) 820 in accordance with various embodiments. The CN 820 may be a core network for a 5G System (which may be referred to as a 5GC). The system 800 is shown to include a UE 801, which may be the same or similar to the UEs 106A, 106B, or 106N discussed previously; a (R)AN 102, which may be the same or similar to the BSs 102A or 102N discussed previously; and a data network (DN) 803, which may be, for example, operator services, Internet access, or 3rd party services; and a CN 820. The CN 820 may include a number of network functions including an Authentication Server Function (AUSF) 822; an Access and Mobility Management Function (AMF) 821; a Session Management Function (SMF) 824; a Network Exposure Function (NEF) 823; a Policy Control Function (PCF) 826; a Network Repository Function (NRF) 825; a Unified Data Management (UDM) 827; an Application Function (AF) 828; a User Plane Function (UPF) 802; and a Network Slice Selection Function (NSSF) 829. These network functions may be implemented, in some cases, as virtualized software based functions/services.

The UPF 802 may act as an anchor point for intra-RAT and inter-RAT mobility, an external packet data unit (PDU) session point of interconnect to DN 803, and a branching point to support mufti-homed PDU session. A PDU session is a logical connection between the UE and the DN. The UPF 802 may also perform packet routing and forwarding, perform packet inspection, enforce the user plane part of policy rules, lawfully intercept packets (user plane (UP) collection), perform traffic usage reporting, perform quality of service (QoS) handling for a user plane (e.g., packet filtering, gating, UL/DL rate enforcement), perform Uplink Traffic verification (e.g., Service Data Flows (SDF) to QoS flow mapping), transport level packet marking in the uplink and downlink, and perform downlink packet buffering and downlink data notification triggering. UPF 802 may include an uplink classifier to support routing traffic flows to a data network, The DN 803 may represent various network operator services, Internet access, or third party services. DN 803 may include, or be similar to, application server 430 discussed previously. The UPF 802 may interact with the SMF 824 via an N4 reference point between the SMF 821 and the UPF 802.

The AUSF 822 may store data for authentication of UE 801 and handle authentication-related functionality, The AUSF 822 may facilitate a common authentication frame work for various access types. The AUSF 822 may communicate with the AMF 821 via an N12 reference point between the AMF 821 and the AUSF 822; and may communicate with the UDM 827 via an N13 reference point between the UDM 827 and the AUSF 822. Additionally, the AUSF 822 may exhibit an Nausf service-based interface.

The AMF 821 may be responsible for registration management (e.g., for registering UE 801, etc.), connection management, reachability management, mobility management, and lawful interception of AMF-related events, and access authentication and authorization. The AMF 821 may be a termination point for the an N11 reference point between the AMF 821 and the SMF 824. The AMF 821 may provide transport for SM messages between the UE 801 and the SMF 824, and act as a transparent proxy for routing SM messages. AMF 821 may also provide transport for Short Message Service (SMS) messages between UE 801 and an SMSF (not shown by FIG. 8). AMF 821 may act as a security anchor function (SEAF), which may include interaction with the AUSF 822 and the UE 801, receipt of an intermediate key that was established as a result of the UE 801 authentication process. Where Universal Subscriber Identity Module (USIM) based authentication is used, the AMF 821 may retrieve the security material from the AUSF 822. AMF 821 may also include a Security Context Management (SCM) function, which receives a key from the SEAF that it uses to derive access-network specific keys. Furthermore, AMF 821 may be a termination point of a RAN control plane (CP) interface, which may include or be an N2 reference point between the (R)AN 810 and the AMF 821; and the AMF 821 may be a termination point of NAS (NI) signaling, and perform NAS ciphering and integrity protection.

AMF 821 may also support NAS signaling with a UE 801 over a non-3GPP Inter-Working Function (N3IWF) interface. The N3IWF may be used to provide access to untrusted entities. N3IWF may be a termination point for the N2 interface between the (R)AN 810 and the AMF 821 for the control plane, and may be a termination point for the N3 reference point between the (R)AN 810 and the UPF 802 for the user plane. As such, the AMF 821 may handle N2 signaling from the SMF 824 and the AMF 821 for PDU sessions and encapsulate/de encapsulate packets for IPSec and N3 tunneling, mark N3 user-plane packets in the uplink, and enforce QoS corresponding to N3 packet marking while considering QoS requirements associated with such marking received over N2. N3IWF may also relay uplink and downlink control plane non-access stratum (NAS) signaling between the UE 801 and AMF 821 via an N1 reference point between the UE 801 and the AMF 821, and relay uplink and downlink user-plane packets between the UE 801 and UPF 802. The N3IWF also provides mechanisms for internet protocol security (IPsec) tunnel establishment with the UE 801. The AMF 821 may exhibit an Namf service based interface, and may be a termination point for an N14 reference point between two AMFs 821 and an N17 reference point between the AMF 821 and a 5G Equipment Identity Register (5G-EIR) (not shown by FIG. 8).

The UE 801 may need to register with the AMF 821 in order to receive network services. Registration Management (RM) is used to register or deregister the UE 801 with the network (e.g., AMF 821), and establish a UE context in the network (e.g., AMF 821). The UE 801 may operate in an RM-REGISTERED state or an RM-DEREGISTERED state. In the RM-DEREGISTERED state, the UE 801 is not registered with the network, and the UE context in AMF 821 holds no valid location or routing information for the UE 801 so the UE 801 is not reachable by the AMF 821. In the RM REGISTERED state, the UE 801 is registered with the network, and the UE context in AMF 821 may hold a valid location or routing information for the UE 801 so the UE 801 is reachable by the AMF 821. In the RM-REGISTERED state, the UE 801 may perform mobility registration update procedures, perform periodic registration update procedures triggered by expiration of the periodic update timer (e.g., to notify the network that the UE 801 is still active), and perform a Registration Update procedure to update UE capability information or to re-negotiate protocol parameters with the network, among others.

The AMF 821 may store one or more RM contexts for the UE 801, where each RM context is associated with a specific access to the network. The RM context may be a data structure, database object, etc. that indicates or stores, inter glia, a registration state per access type and the periodic update timer. The AMF 821 may also store a 5GC mobility management (MM) context that may be the same or similar to the evolved packet services (EPS) Mobility Management (E)MM context discussed previously. In various embodiments, the AMF 821 may store a CE mode B Restriction parameter of the UE 801 in an associated MM context or registration management (RM) context. The AMF 821 may also derive the value, when needed, from the UE's usage setting parameter already stored in the UE context (and/or MM/RM context).

Connection Management (CM) may be used to establish and release a signaling connection between the UE 801 and the AMF 821 over the N1 interface. The signaling connection is used to enable NAS signaling exchange between the UE 801 and the CN 820, and comprises both the signaling connection between the UE and the AN (e.g., RRC connection or UE-N3IWF connection for non-3GPP access) and the N2 connection for the UE 801 between the AN (e.g., AN 810) and the AMF 821. The UE 801 may operate in one of two CM states, CM-IDLE mode or CM-CONNECTED mode. When the UE 801 is operating in the CM-IDLE state/mode, the UE 801 may have no NAS signaling connection established with the AMF 821 over the N1 interface, and there may be (R)AN 810 signaling connection (e.g., N2 and/or N3 connections) for the UE 801. When the UE 801 is operating in the CM-CONNECTED state/mode, the UE 801 may have an established NAS signaling connection with the AMF 821 over the NI interface, and there may be a (R)AN 810 signaling connection (e.g., N2 and/or N3 connections) for the UE 801. Establishment of an N2 connection between the (R)AN 810 and the AMF 821 may cause the UE 801 to transition from CM-IDLE mode to CM-CONNECTED mode, and the UE 801 may transition from the CM-CONNECTED mode to the CM-IDLE mode when N2 signaling between the (R)AN 810 and the AMF 821 is released.

The SMF 824 may be responsible for session management (SM) session establishment, modify and release, including tunnel maintain between UPF and AN node); UE IP address allocation and management (including optional authorization); selection and control of UP function; configuring traffic steering at UPF to route traffic to proper destination; termination of interfaces toward policy control functions; controlling part of policy enforcement and QoS; lawful intercept (for SM events and interface to LI system); termination of SM parts of NAS messages; downlink data notification; initiating AN specific SM information, sent via AMF over N2 to AN; and determining SSC mode of a session. SM may refer to management of a PDU session, and a PDU session or “session” may refer to a PDU connectivity service that provides or enables the exchange of PDUs between a UE 801 and a data network (DN) 803 identified by a Data Network Name (DNN). PDU sessions may be established upon UE 801 request, modified upon UE 801 and CN 820 request, and released upon UE 801 and CN 820 request using NAS SM signaling exchanged over the N1 reference point between the UE 801 and the SMF 824. Upon request from an application server, the CN 820 may trigger a specific application in the UE 801. In response to receipt of the trigger message, the UE 801 may pass the trigger message (or relevant parts/information of the trigger message) to one or more identified applications in the UE 801. The identified application(s) in the UE 801 may establish a PDU session to a specific data network name (DNN). The SMF 824 may check whether the UE 801 requests are compliant with user subscription information associated with the UE 801. In this regard, the SMF 824 may retrieve and/or request to receive update notifications on SMF 824 level subscription data from the UDM 827.

The SMF 824 may include the following roaming functionality: handling local enforcement to apply QoS SLAB virtual Public Land Mobile Network (VPLMN); charging data collection and charging interface (VPLMN); lawful intercept (in VPLMN for SM events and interface to LI system); and support for interaction with external DN for transport of signaling for PDU session authorization/authentication by external DN. An N16 reference point between two SMFs 824 may be included in the system 800, which may be between another SMF 824 in a visited network and the SMF 824 in the home network in roaming scenarios. Additionally, the SMF 824 may exhibit the Nsmf service-based interface.

The NEF 823 may provide means for securely exposing the services and capabilities provided by 3GPP network functions for third party, internal exposure/re-exposure, Application Functions (e.g., AF 828), edge computing or fog computing systems, etc. In such embodiments, the NEF 823 may authenticate, authorize, and/or throttle the AFS. NEF 823 may also translate information exchanged with the AF 828 and information exchanged with internal network functions. For example, the NEF 823 may translate between an AF-Service-Identifier and an internal SCC information. NEF 823 may also receive information from other network functions (NFs) based on exposed capabilities of other network functions. This information may be stored at the NEF 823 as structured data, or at a data storage NF using standardized interfaces. The stored information can then be re-exposed by the NEF 823 to other NFs and AFs, and/or used for other purposes such as analytics. Additionally, the NEF 823 may exhibit an Nnef service-based interface.

The NRF 825 may support service discovery functions, receive NF discovery requests from NF instances, and provide the information of the discovered NF instances to the NF instances. NRF 825 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 825 may exhibit the Nnrf service based interface.

The PCF 826 may provide policy rules to control plane function(s) to enforce them, and may also support unified policy framework to govern network behavior, The PCF 826 may also implement a front end (FE) to access subscription information relevant for policy decisions in a UDR of the UDM 827. The PCF 826 may communicate with the AMF 821 via an N15 reference point between the PCF 826 and the AMF 821, which may include a PCF 826 in a visited network and the AMF 821 in case of roaming scenarios. The PCF 826 may communicate with the AF 828 via an NS reference point between the PCF 826 and the AF 828; and with the SMF 824 via an N7 reference point between the PCF 826 and the SMF 824, The system 800 and/or CN 820 may also include an N24 reference point between the PCF 826 (in the home network) and a PCF 826 in a visited network, Additionally, the PCF 826 may exhibit an Npcf service-based interface.

The UDM 827 may handle subscription-related information to support the network entities'handling of communication sessions, and may store subscription data of UE 801. For example, subscription data may be communicated between the UDM 827 and the AMF 821 via an NS reference point between the UDM 827 and the AMF. The UDM 827 may include two parts, an application FE and a UDR (the FE and UDR are not shown by FIG. 8). The UDR may store subscription data and policy data for the UDM 827 and the PCF 826, and/or structured data for exposure and application data (including PFDs for application detection, application request information for multiple UEs 801) for the NEF 823. The Nadr service-based interface may be exhibited by the UDR to allow the UDM 827, PCF 826, and NEF 823 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. The UDR may interact with the SMF 824 via an NI0 reference point between the UDM 827 and the SMF 824. UDM 827 may also support SMS management, wherein an SMS-FE implements the similar application logic as discussed previously. Additionally, the UDM 827 may exhibit the Nudm service based interface.

The AF 828 may provide application influence on traffic routing, provide access to the NCE, and interact with the policy framework for policy control. The NCE may be a mechanism that allows the CN 820 and AF 828 to provide information to each other via NEF 823, which may be used for edge computing implementations. In such implementations, the network operator and third party services may be hosted close to the UE 801 access point of attachment to achieve an efficient service delivery through the reduced end-to-end latency and load on the transport network. For edge computing implementations, the 5GC may select a UPF 802 close to the UE 801 and execute traffic steering from the UPF 802 to ON 803 via the N6 interface. This may be based on the UE subscription data, UE location, and information provided by the AF 828. In this way, the AF 828 may influence UPF (re)selection and traffic routing. Based on operator deployment, when AF 828 is considered to be a trusted entity, the network operator may permit AF 828 to interact directly with relevant NFs. Additionally, the AF 828 may exhibit an Naf service-based interface.

The NSSF 829 may select a set of network slice instances serving the UE 801. The NSSF 829 may also determine allowed Network Slice Selection Assistance Information (NSSAI) and the mapping to the subscribed single NSSAI (S-NSSAI) is, if needed. The NSSF 829 may also determine the AMF set to be used to serve the UE 801, or a list of candidate AMF(s) 821 based on a suitable configuration and possibly by querying the NRF 825. The selection of a set of network slice instances for the UE 801 may be triggered by the AMF 821 with which the UE 801 is registered by interacting with the NSSF 829, which may lead to a change of AMF 821. The NSSF 829 may interact with the AMF 821 via an N22 reference point between AMF 821 and NSSF 829; and may communicate with another NSSF 829 in a visited network via an N31 reference point (not shown by FIG. 8). Additionally, the NSSF 829 may exhibit an Nnssf service-based interface.

As discussed previously, the CN 820 may include a short message service function (SMSF), which may be responsible for SMS subscription checking and verification, and relaying SM messages to/from the UE 801 to/from other entities, such as an SMS-GMSC/IWMSC/SMS-router. The SMS may also interact with AMF 821 and UDM 827 for a notification procedure that the UE 801 is available for SMS transfer (e.g., set a UE not reachable flag, and notifying UDM 827 when UE 801 is available for SMS).

The CN 820 may also include other elements that are not shown by FIG. 8, such as a Data Storage system/architecture, a 5G-EIR, a Security Edge Protection Proxy (SEPP), and the like. The Data Storage system may include a Structured Data Storage Network Function (SDSF), air Unstructured Data Storage Function (UDSF), and/or the like. Any network function (NF) may store and retrieve unstructured data into/from the UDSF (e.g., UE contexts), via N18 reference point between any NF and the UDSF (not shown by FIG. 8), Individual NFs may share a UDSF for storing their respective unstructured data or individual NFs may each have their own UDSF located at or near the individual NFs. Addition ally, the UDSF may exhibit an Nudsf service-based interface (not shown by FIG. 8). The 5G-EIR may be an NF that checks the status of permanent equipment identifier (PEI) for determining whether particular equipment/entities are blacklisted from the network; and the SEPP may be a non-transparent proxy that performs topology hiding, message filtering, and policing on inter-PLMN control plane interfaces.

Additionally, there may be many more reference points and/or service-based interfaces between the NF services in the NFs; however, these interfaces and reference points have been omitted from FIG. 8 for clarity. In one example, the CN 820 may include an Nx interface, which is an inter-CN interface between a mobility management entity (MME) and the AMF 821 in order to enable interworking between CN 820 and a CN in a 4G system. Other example interfaces/reference points may include an N5G-EIR service-based interface exhibited by a 5G-EIR, an N27 reference point between the NRF in the visited network and the NRF in the home network; and an N31 reference point between the NSSF in the visited network and the NSSF in the home network.

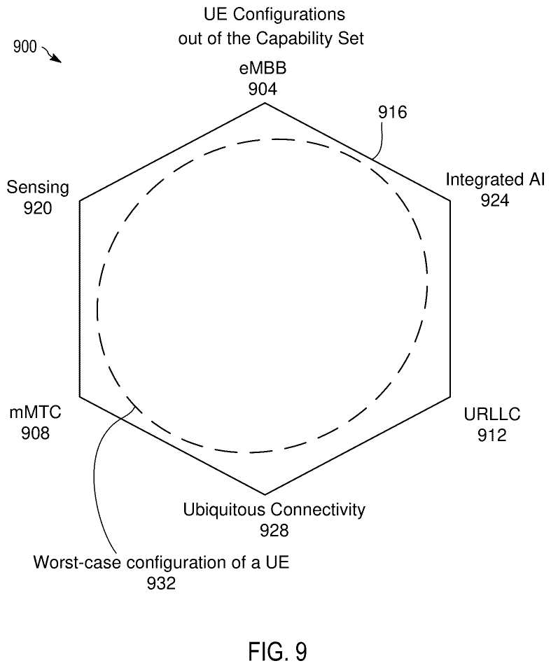

### FIG. 9: UE Capabilities, UE Categories and UE Configuration

FIG. 9 illustrates a diagram 900 of an example UE configuration out of a capability set, according to some embodiments.

Taking into consideration the new sixth generation (6G) new radio (NR) use cases and the new UE capabilities that will be associated with them, the current method of indicating one common set of UE capabilities covering every vertical (aka role of a UE) becomes even more challenging than in 5G. The 5G design aspects aimed to have extreme flexibility to cover all aspects of the Enhanced Mobile Broadband (eMBB) 904, Massive Machine-Type Communications (mMTC) 908, and Ultra-Reliable and Low Latency Communications (URLLC) 912 triangle.

For 6G, it has become a hexagon 916 of complementary capabilities. The UE may be used to cover sensing 920, integrated Artificial Intelligence (AI) 924 and ubiquitous connectivity 928. The UEs are required to support many different capabilities, sometimes even mutually exclusive capabilities. All combinations may be possible 932 as a result of this extreme flexibility and the UEs may become very costly.

With respect to UE capabilities, a super-set of features that a UE supports is signaled to the NW. For example, in 5G, a UE signals possible values of certain parameters (i.e., in the simplest case maximum numbers) and support of all kinds of contradicting UE features, which does not necessarily make sense to be enabled at the same time. This leads to extreme UE complexity since any combination could be configured at any time. Some capabilities are static and agreed upon on UE registration with the NW. It may not be possible to signal different roles to the NW or switch between different roles dynamically.

With respect to UE configuration, an explicit set of UE features are to be enabled along with their corresponding parameters. These are based on the supported features from the signaled UE capabilities and the corresponding BS/NW capabilities. Any combination of UE features could be configured, thus making the signaling of those settings very complex (i.e., message size, latency to transfer the configuration). A huge burden can be put on the UE to accept any configuration at any time for any feature combination. In addition, UE configuration can be very dynamic. The UE configuration can potentially change at any time, especially during mobility or change in NW conditions (e.g., cell load changes).

UE Categories can be defined throughput classes, in the physical (PHY) layer only, and driven by device types, not by the use case.

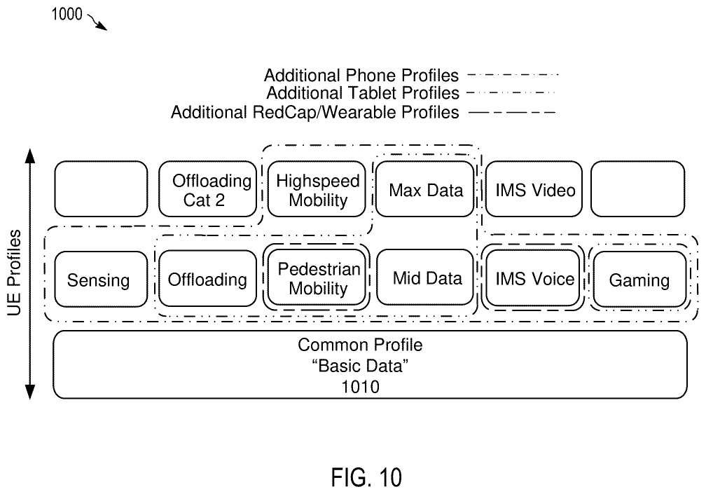

### FIGS. 10-13: UE Profiles

FIG. 10 illustrates a diagram of example UE profiles 1000, according to some embodiments.

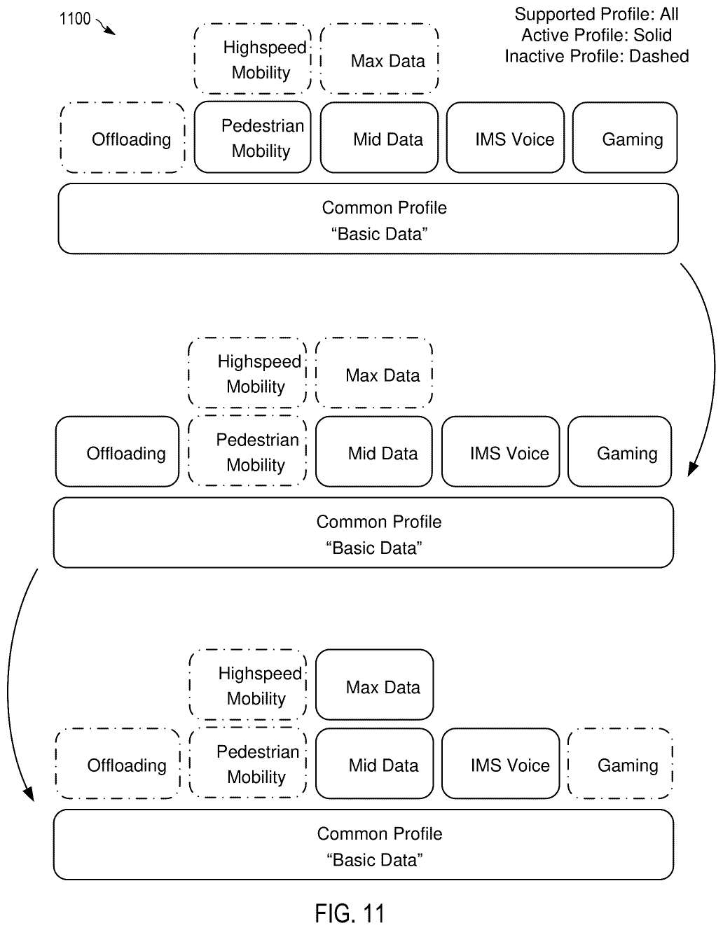

FIG. 11. illustrates a diagram of example active profile change 1100 on a UE, according to some embodiments.

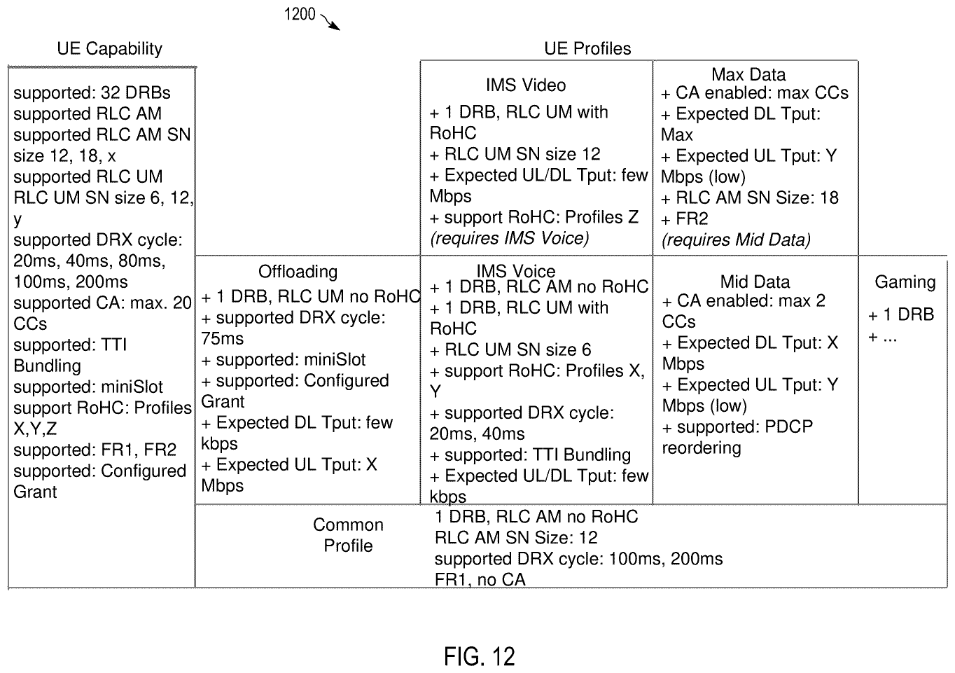

FIG. 12 illustrates a diagram of example UE profiles 1200 and parameters, according to some embodiments.

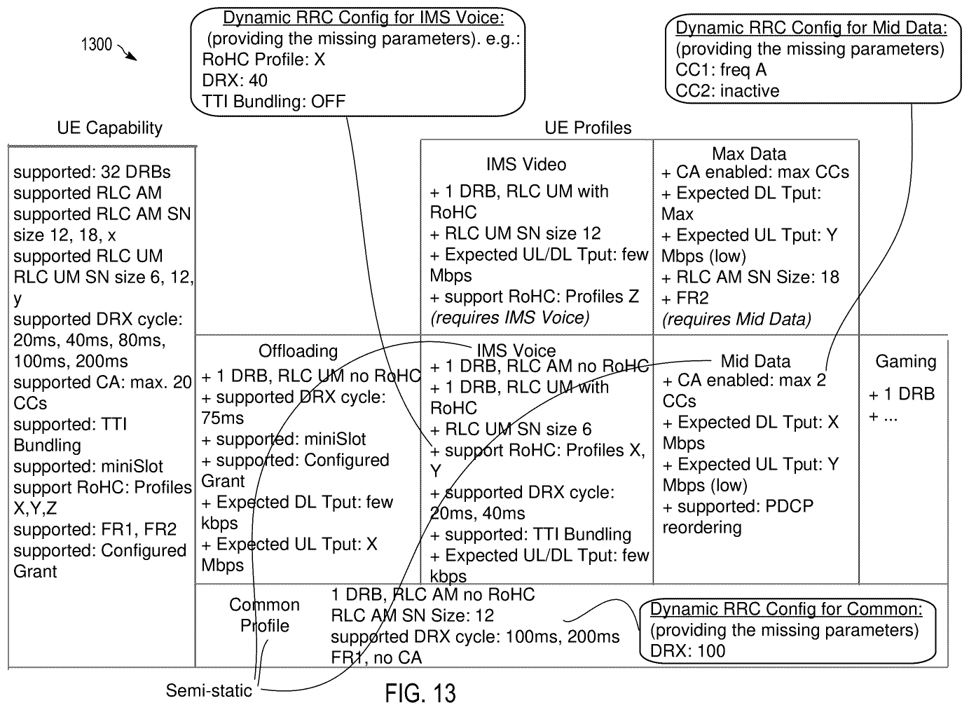

FIG. 13 illustrates a diagram of example UE profiles 1300 with semi-static and dynamic parameters, according to some embodiments.

To mitigate the gap between the very static UE capabilities, where a UE cannot change its feature envelope without interruption (i.e. deregistration and registration), and the very dynamic configuration, that can change any setting instantly, UE profiles can be defined that go beyond legacy UE categories that are driven by concept of device types and not by use cases. The UE profiles can cover features on all layers, e.g. supported Layer 2 (L2) and Layer 3 (L3) procedures, and can lead towards profile-specific specifications (e.g. radio resource control (RRC) specifications). The UEs may activate and deactivate profiles (supported feature set) more dynamically in order to take a different role and/or responsibility in the NW (i.e., UE verticals), as shown in FIG. 11. The profiles can be use case driven. Active profiles can limit the flexibility in dynamic configuration, with a smaller active feature envelope, leading to lighter RRC configurations.

The UE profiles can be a pre-determined meaningful subset of UE capabilities, grouped together to define a certain UE role based on the individual UE capabilities. The UE profiles can be 3GPP/Operator-defined, or UE-NW negotiated. The UE profiles can be signaled as new information elements (IEs) in the UE capabilities messaging or as a separate procedure with the NW.

The UE can support a very basic, common profile and may activate different additional profiles towards the NW when the UE changes in its behavior or user configuration (UC), e.g. when the UE is acting as a different “UE vertical”, resulting in a different feature set being active. For example, the UE can start and/or stop acting as an IMS Voice UE; or start and/or stop acting as an Offloading UE optimized to offload or accept offloading; or start and/or stop acting as a Management Node (MgtN) relaying heavy download (DL) traffic towards trusted UEs.

The UE profiles can be valid across radio access technologies (RATs), while their individual feature set per RAT could be different. Some RATs may be down-prioritized or disabled for certain profiles (e.g., 5G and Frequency Range 2 (FR2) could be removed from a very basic profile).

The UE profiles can be used to enable more semi-static configurations, as they imply certain features and configurations and can define many parameters. This may also be common for the whole radio access network/public land mobile network (RAN/PLMN), while only some of the parameters can be left for individual configuration (e.g., via RRC configuration). For example, a typical data radio bearer (DRB) configuration can contain 2 radio link control (RLC) acknowledge mode (AM) bearers with certain sequence number (SN) sizes, and a subset of possible discontinuous reception (DRX) cycles, whereas the configuration of individual bearer identifications (IDs) or which DRX cycle to be used could be for RRC configuration. The NW can control the UEs'individual configuration within this smaller capability envelope, while the UE complexity is reduced.

Referring to FIG. 10, the UE can support a Common Base Profile 1010 and different profiles in addition to the Common Base Profile that can be enabled or disabled dynamically (i.e., UE initiated). Smaller UE devices (e.g. reduced capacity (RedCap) or wearable devices) may support fewer profiles and enable and disable them on demand. For example, a smart watch may signal support for the Common Base Profile 1010 and an IMS Voice capability or profile. The IMS Voice profile can be activated on demand. In addition, smaller UE devices may support fewer active profiles in parallel, e.g. only the IMS Voice profile or a Mid Data profile.

More capable UE devices, like cellular phones, may have to support many, if not all, features. Hardware (HW) complexity may be reduced compared to classical UE capabilities if not all features have to be active at the same time. For example, a cellular phone UE device may support a Gaming profile, an Offloading profile, and a Max Data profiles. Although each profile can exist in parallel to the IMS Voice, they may be mutually exclusive. Thus, not all supported profiles may be active at the same time. Power saving can be achieved when certain profiles beyond the Common Base Profile are deactivated.

Referring to FIG. 12, a UE capability may be static, exchanged during registration, and use registration to change. In addition, UE capabilities can be a fine granular set of features that a UE supports, and of which all combinations are possible resulting in potentially very complex configurations. For example, by indicating the exemplary UE Capability, a UE device may be configured to accept 32 Radio Bearers, an RLC AM and an unacknowledged mode (UM) with maxed out sequence number ranges (i.e., defining the reordering window size), and Robust Header Compression (RoHC) on Packet Data Convergence Protocol (PDCP), all on the theoretical maximum throughput in uplink (UL) and downlink (DL); requiring huge over-dimensioning of the UE HW.

The UE profiles can reduce the active capabilities a UE supports and reduce configuration space a UE covers, and thereby the HW complexity to cover any combination of features (e.g. memory and processing requirements). The UE profiles go beyond legacy UE categories by also covering L2 complexity, supported L2/L3 procedures, and define different subsets of features from PHY to L3 leading towards profile specific specifications.

Again, referring to the example, the Common Profile may support only 1 DRB in RLC AM and no ROHC. With respect to the IMS Voice Profile, RoHC is only supported on 1 DRB in RLC UM, in total only 2 DRBs (1 RLC AM for IMS signaling, 1 RLC UM for voice), so that Tput on the RoHC bearer is limited to a few bytes, so small SN sizes are sufficient. Some features, like TTI bundling might be optional for to the NW to configure. DRX may be supported (with a subset of configurable parameters useful for VoIP: 20 ms, 40 ms). The resulting Active Capability may be only the Common Profile and the IMS Voice Profile.

To balance the HW requirements, a UE could support either the Offloading profile, which is very UL heavy, or Max Data, which is very DL heavy; but not both at the same time. This may enable the UE to switch roles by enabling/disabling profiles dynamically, i.e. without interruption and re-registration

The profile may already be a partial configuration, for which the UE and the NW can derive many parameters. This can reduce necessary configurations by the NW.

Referring to FIG. 13, because the UE profile can be a narrowed down subset of all UE capabilities, the UE profile may also define a partial UE configuration. The UE profile and/or the partial UE configuration can comprise two components, namely semi-static parameters and dynamic parameters. The semi-static parameters can comprise tracking area (TA), radio access network (RAN) area, and Public Land Mobile Network (PLMN) wide parameters and configurations, characteristics for a certain UE profile (such as IMS Voice), and major parts of the L2 configuration. The dynamic parameters can comprise base station and cell specific configurations (such as individual DRX settings), and neighbor cells depending on the individual base station capabilities and load situation. Examples of dynamic parameters include the L1 configurations, number of component carriers (CCs), IDs, and frequencies. Mobility, while the same UE profiles are active, may only impact the dynamic parameters while the semi-static parameters may remain the same. In other words, as a UE moves between base stations or nodes, the dynamic parameters can be updated while the semi-static parameters can remain unchanged. Profile activation/deactivation may affect semi-static parameters and may cause dynamic parameters to change as well. The semi-static parameters can be the same across different base stations (BS) or timing advances, or even public land mobile network (PLMN) wide, i.e. they do not need to be configured all the time when a UE moves to another BS.

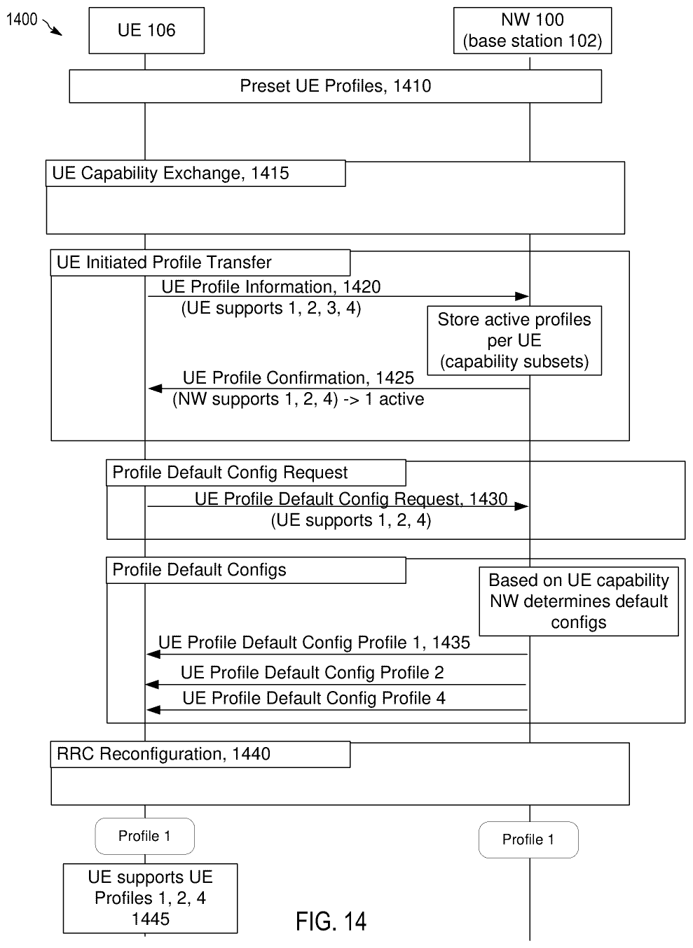

### FIG. 14: UE Profile Agreement and Modification

FIG. 14 illustrates an example signaling 1400 of UE profiles between a UE and a base station, according to some embodiments.

The UE profiles may have a prerequisite that the list of UE profiles is pre-determined, indicated at 1410. For example, the UE profiles can be 3GPP-defined, operator-defined or negotiated between the UE 106 and the NW 100.

A signaling procedure can comprise the UE 106 signaling (i.e. generating or encoding for transmission by the processors) a UE capabilities message to the NW 100 (e.g. via the base station or gNB 102). The UE signaling can be part of a capability exchange 1415 with the NW 100. The UE capabilities message can comprise all or substantially all the UE capabilities.

The UE 106 can signal (i.e. generate or encode for transmission by the processors) a UE profiles information message 1420 comprising supported UE profiles from the list of UE profiles. The UE profiles information message can include default active profile(s). The NW 100 can signal (i.e. generate for transmission by processors), and the UE 106 can receive or decode using its processors, a UE profile confirmation message 1425 that provides supported UE profiles that the UE 106 is allowed to use.

According to some examples, the UE 106 can request, i.e. signal a profile default configuration request 1430 for, a set of semi-static, default configurations in addition to pre-determined semi-static parameters.

According to some examples, the NW 100 can provide the UE 106 with the requested semi-static configurations per UE profile, in a UE profile default configuration profile 1435, e.g. a smaller selection of DRX options, or PLMN wide use of TTI-bundling.

The UE 106 can receive (or decode) a dynamic configuration 1440 from the NW 100 according to the active UE profile.

According to some examples, upon change of the user configuration (UC), the UE 106 may indicate a profile change any time 1445, as described in greater detail below.

Because the set of active UE profiles can change dynamically and the corresponding semi-static configuration profiles are valid across base stations (gNBs 102) in the RAN, procedures to distribute and align within the RAN may be needed as described below.

In one aspect, an apparatus of a user equipment (UE) 106 can comprise one or more processors 402 and/or 604 coupled to a memory 406 and/or 604G. The processors 604 can be configured to generate (and/or encode for transmission), at the UE 106, a UE profile message 1420 for transmission to a network (NW) 100 via a base station 102. The UE profile message 1420 indicates support of one or more select UE profiles from a list of pre-determined UE profiles 1410, and indicates which of the one or more select UE profiles is an active UE profile at the UE. Each UE profile comprises a pre-determined subset of individual UE capability features grouped together to define a UE role in the NW 100. The processors 604 can be configured to receive (or decode), at the UE, a UE profile confirmation message 1425 from the NW 100 via the base station 102 indicating UE profiles supported by the NW 100 and acknowledging active UE profiles.

In another aspect, the processors 604 can be further configured to receive, at the UE 106, a reconfiguration message 1440 from the NW 100 via the base station 102 comprising a new UE configuration based on the UE profile message 1420.

In another aspect, the one or more select UE profiles can further comprise a basic profile 1010 of individual UE capabilities common to all UE profiles.

In another aspect, the processors 402 can be further configured to identify, at the UE 106, a role of the UE 106 with the active UE profile based on the role identified by the UE 106.

In another aspect, the processors 402 can be further configured to initiate, at the UE 106, one or more select UE profiles from the list of pre-determined UE profiles 1410.

In another aspect, the processors 402 can be further configured initiate, at the UE 106, which of the one or more select UE profiles is the active UE profile at the UE 106.

In another aspect, the UE profile message 1420 can further comprises a select profile that comprises a pre-determined subset of individual UE capability features grouped together to define a UE role in the NW 100 to enable the UE 106 to dynamically switch roles.

In another aspect, the active UE profile can reduce the active capabilities supported by the UE 106.

In another aspect, the active UE profile can be based on a change in user configuration (UC) of the UE 106.

In another aspect, at least one of the one or more select UE profiles can be inactive while at least one of the one or more select UE profiles is active.

In another aspect, the processors 402 can be further configured to enable and disable, at the UE 106, the one or more select UE profiles.

In another aspect, at least one of the one or more select UE profiles can comprise semi-static parameters that are the same; and dynamic parameters that are changed.

In another aspect, the processors 604 can be further configured to generate, at the UE 106, a UE profile default configuration request 1430 for transmission to the NW 100 via the base station 102. The UE profile default configuration request 1430 can comprise a set of semi-static default configurations in addition to a pre-determined semi-static parameter. In another aspect, the processors 604 can be further configured to receive, at the UE 106, one or more UE profile default configuration profiles 1435 from the NW 100 via the base station 102. The one or more UE profile default configuration profiles 1435 can comprise a set of semi-static default configurations in addition to pre-determined semi-static parameters.

In another aspect, the processors 402 can be further configured to change the UE role without deregistration and re-registration with the NW 100.

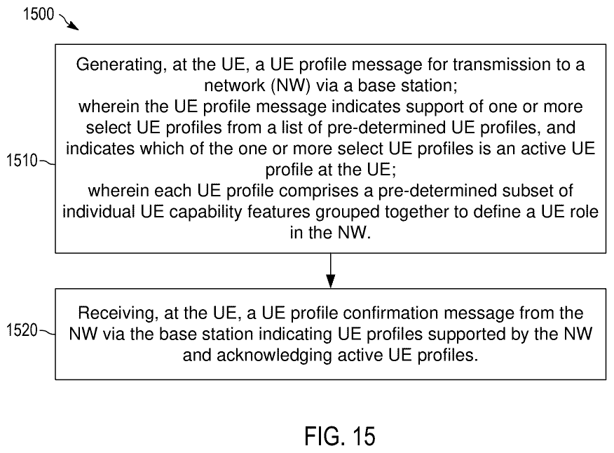

### FIG. 15: Flow Chart for a Method of Signaling UE Capabilities

FIG. 15 illustrates a flow chart of an example of a method for signaling UE capabilities and profiles, according to some embodiments. The method shown in FIG. 15 may be used in conjunction with any of the systems, methods, or devices illustrated in the Figures, among other devices. In various embodiments, some of the method elements shown may be performed concurrently, in a different order than shown, or may be omitted. Additional method elements may also be performed as desired.

The method 1500 can comprise generating 1510, at the UE, a UE profile message for transmission to a network (NW) via a base station. The UE profile message indicates support of one or more select UE profiles from a list of pre-determined UE profiles, and indicates which of the one or more select UE profiles is an active UE profile at the UE. Each UE profile comprises a pre-determined subset of individual UE capability features grouped together to define a UE role in the NW. The method 1500 can comprise receiving 1520, at the UE, a UE profile confirmation message from the NW via the base station indicating UE profiles supported by the NW and acknowledging active UE profiles.

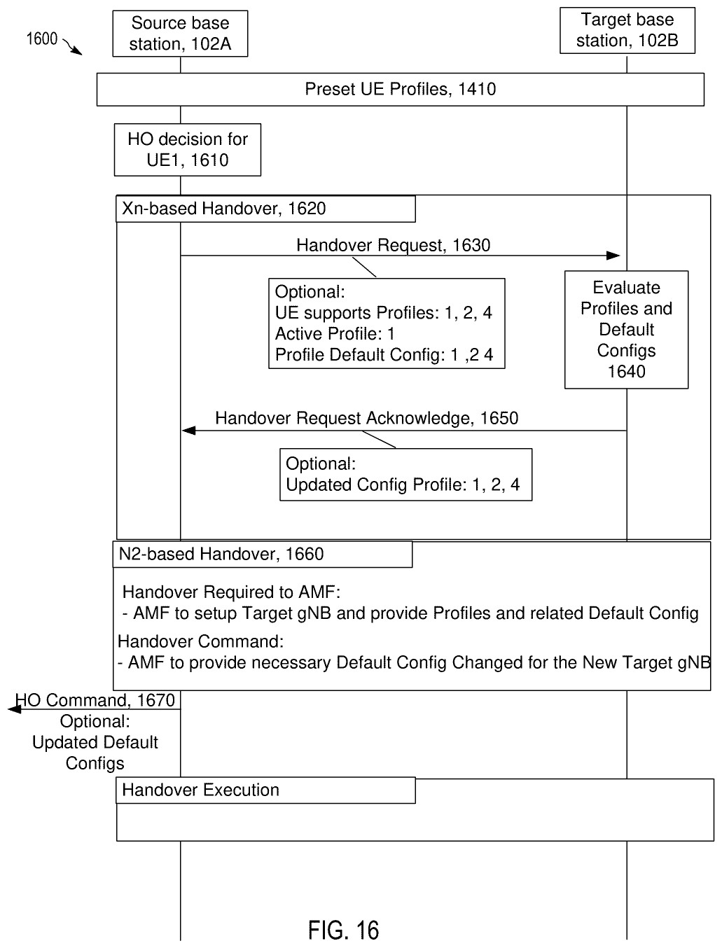

### FIG. 16: UE Profile and Default Configuration Distribution

FIG. 16 illustrates an example signaling 1600 of UE profiles between a source base station and a target base station, according to some embodiments.

A signaling procedure 1600 is shown to exchange active UE profiles and related default configurations within a RAN to prepare a target gNB in case of a handover (HO). The source base station or gNB 102A can make a HO decision 1610.

The HO can be an Xn-based HO 1620 with profile exchange and potential update. The source base station or gNB 102A can share the active profile(s) and default configuration information in a handover request 1630. The target base station or gNB 102B can evaluate 1640 the configuration for the active profile(s). The active profile(s) configuration may require changes that can be signaled back to the source base station or gNB 102A in a handover request acknowledgement 1650.

Other HO types 1660 can also include a profile exchange and a potential update. The other HO types (e.g. N2-based, N14-based, etc.) might involve Access and Mobility Management Function (AMF) interaction to propagate the UE profile and default configuration information and setup the target base station, such as a 5G gNB or 6G base station 102B.

The HO command 1670 from the AMF may contain updates, similarly to the Xn-based HO. The source base station or gNB 102A may inform the UE 106 with the updated active profile configuration via a HO command and the HO is executed.

A conditional handover (CHO) can be extended to contain supported profiles in configured cells. The UEs 106 can have additional criteria to determine for HO based on the profile information similar for LTM. The preparation can be similar, but the NW can determine considering profile information by sending a MAC CE.

To improve the IDLE mode mobility and latency of connection establishment, the base station may broadcast the supported profiles in System Information Blocks (SIBs) and enable UEs to camp only on specific cells, e.g. that support offloading.

In one aspect, the processors 604 can be further configured to receive, at the UE 106, a handover (HO) command 1670 from a source base station 102A. The HO command 1670 can be based on an exchange between the source base station 102A and a target base station 102B regarding an active UE profile and default configuration information.

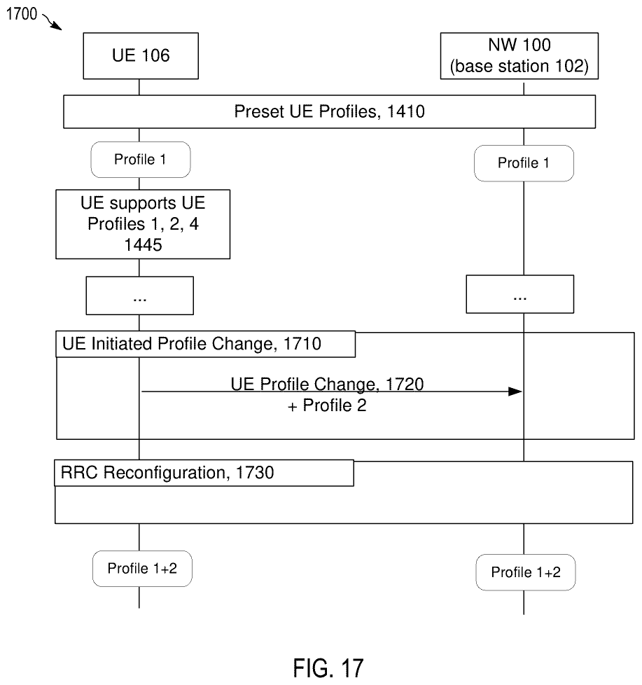

### FIG. 17: UE Initiated Profile Change

FIG. 17 illustrates an example signaling 1700 of UE profiles between a UE and a base station, according to some embodiments.

The NW 100 can maintain the UE profiles per UE where the UE 106 may activate the UE profiles dynamically based on the active user configuration (UC) required from the UE difference to the legacy UE categories that are more driven by device types. As indicated above, upon change of the user configuration (UC), the UE 106 may indicate a profile change any time 1445. The profile change can be UE-initiated profile change 1710 in an explicit UE profile change 1720 to announce a change in UE behavior and requirements. The UE-initiated profile change 1710 enables the UE to switch between different roles, e.g. becoming a reduced capability (RedCap) UE for enhanced power saving. This could be by RRC signaling, or MAC CE for low latency switching. The UE profiles may not only indicate a change in the set of UE capabilities, but the UE profile may correspond to a different UE vertical where some function(s) are unnecessary.

The change of active profiles may remove employed functions of the protocol stack completely or vice versa, e.g. switching from 6G stack with Service Data Adaptation Protocol (SDAP), Packet Data Convergence Protocol (PDCP), Radio Link Control (RLC), or Medium Access Control (MAC) to something different like MAC-only 6G for a device in extreme power saving only sending location status periodically.

In one aspect, the processors 604 can be further configured to generate, at the UE 106, a UE profile change message 1720 for transmission to the NW 100 via the base station 102. The UE profile change message 1720 comprises a select UE profile that comprises a pre-determined subset of individual UE capability features grouped together to define a UE role in the NW to enable the UE to dynamically switch roles.

In another aspect, the processors 604 can be configured to further receive, at the UE 106, a reconfiguration message 1730 from the NW 100 via the base station 102 comprising a new UE configuration based on the select profile of the UE profile change message 1720.

In another aspect, the processors 402 can be further configured to change the UE role in the NW 100 based on the reconfiguration message 1730.

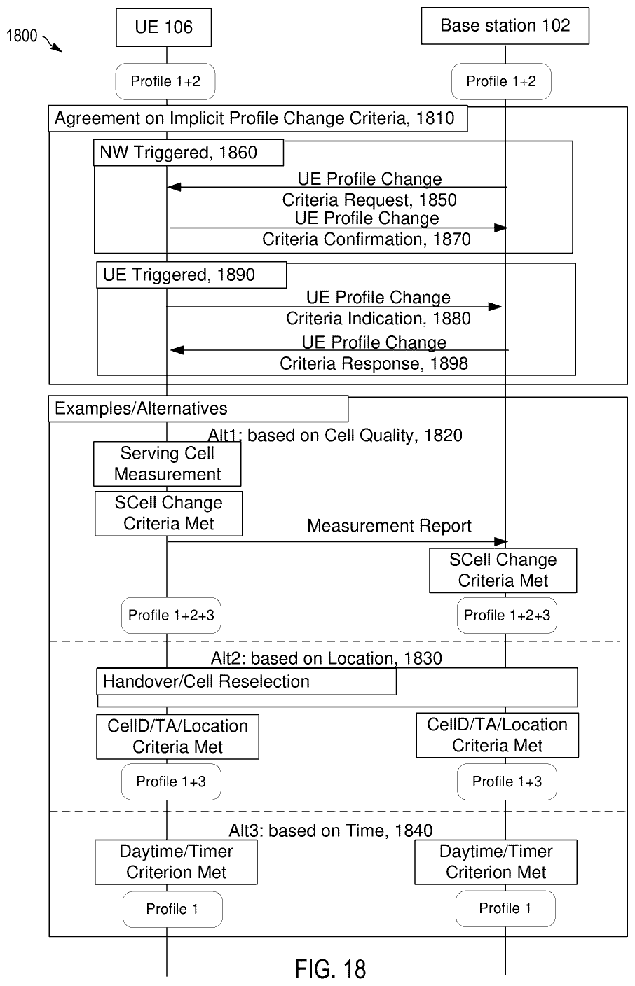

### FIG. 18: Implicit Profile Change

FIG. 18 illustrates an example signaling 1800 of implicit UE profile changes between a UE and a base station, according to some embodiments.

Contextual detection using AI/ML may be used on both sides (the UE 106 and the NW 100) to decide on profile changes. The NW 100 and the UE 106 may also agree 1810 on implicit parameters to change active UE profiles, e.g. cell quality 1820, location 1830, time 1840 and/or activity base. The cell quality 1820 can be based on reported radio frequency (RF) conditions (e.g. serving cell quality below a RSRP=X or above a RSRP=Y). The location 1830 can be based on geographic location, tracking area, and/or cell IDs, e.g. based on SIB information in Idle Mode, or active cells in HO commands. The time 1840 can be based on daytime, or Idle/Inactive Timers. The activity can be based on an amount of data transferred within a certain window, mobility patterns, and/or motion speed.

Agreements on timing/delay from meeting certain criteria until activating/deactivating certain profiles, as well as some hysteresis for profile changes, can be agreed upon between the UE 106 and the NW 100 to ensure that they both remain in sync. For example, the agreements can be specification defined or configured in the initial agreement step.

In one aspect, the processors 604 can be further configured to receive, at the UE 106, a UE profile change criteria request message 1850 from the NW 100 via the base station 102. Thus, the UE profile change criteria can be NW triggered 1860. The UE profile change criteria request message 1850 can comprise a criteria request based on one or more of cell quality 1820, location 1830, time 1840 or activity. The processors 604 can generate, at the UE 106, a UE profile change criteria confirmation message 1870 for transmission to the NW 100 via the base station 102.

In another aspect, the processors 604 can be further configured to generate, at the UE 106, a UE profile change criteria indication message 1880 for transmission to the NW 100 via the base station 102. Thus, the UE profile change criteria can be UE triggered 1890. The UE profile change criteria indication message 1880 can comprise a criteria request based on one or more of cell quality 1820, location 1830, time 1840 or activity. The processors 604 can receive, at the UE 106, a UE profile change criteria response message 1898 from the NW 100 via the base station 102.

With respect to cell quality 1820, the UE 106 can make serving cell measurements. The UE 106 can determine when the cell quality criteria are met with respect to a secondary cell (SCell). The processors 604 can be configured to generate a measurement report for transmission to the NW 100 via the base station or gNB 102. The NW 100 or the base station or gNB 102 can determine when the cell quality criteria are met with respect to the SCell. The UE 106 and the NW 100 can change the UE profile.

With respect to location 1830, the UE 106 and the NW 100 or base station or gNB 102 can determine HO or cell reselection based on the location criteria, e.g. CellD, timing advance (TA) and/or location. The UE 106 and the NW 100 can change the UE profile.

With respect to time 1840, the UE 106 and the NW 100 or base station or gNB 102 can determine when the time criteria have been met. The UE 106 and the NW 100 can change the UE profile.

In one aspect, a baseband processor (e.g. baseband processor 600 or 604), or functionally similar component(s)) whose function may include supporting baseband layer operations (e.g., to facilitate wireless communication between the UE 106 and other wireless devices) in the UE 106, can be configured to cause the UE 106 to perform any of the methods or operations described herein. In another aspect, the UE 106 can have one or more processors (e.g. processors 402 and/or 600 or 604) coupled to a memory 406 or 604G to cause the user equipment 106 to perform any of the methods described herein. In another aspect, a baseband processor (e.g. baseband processor 600 or 604 can be configured to cause a base station 102 to perform one or more of the methods or operations described herein. In another aspect, the base station 102 can have one or more processors 204 and/or 600 or 604 coupled to memory 260 or 604G configured to cause the base station 102 to perform any of the methods described herein. In another aspect, a computer program product, comprising computer instructions which, when executed by one or more processors, can perform any of the operations described herein.

Embodiments of the present disclosure may be realized in any of various forms. For example, some embodiments may be realized as a computer-implemented method, a computer readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus of a user equipment (UE) comprising:
one or more processors, coupled to a memory, configured to:
generate, at the UE, a UE profile message for transmission to a network (NW) via a base station;
wherein the UE profile message indicates support of one or more select UE profiles from a list of pre-determined UE profiles, and indicates which of the one or more select UE profiles is an active UE profile at the UE;
wherein each UE profile comprises a pre-determined subset of individual UE capability features grouped together to define a UE role in the NW; and
receive, at the UE, a UE profile confirmation message from the NW via the base station indicating UE profiles supported by the NW and acknowledging active UE profiles.

2. The apparatus of claim 1, wherein the one or more processors are further configured to:
receive, at the UE, a reconfiguration message from the NW via the base station comprising a new UE configuration based on the UE profile message.

3. The apparatus of claim 1, wherein the one or more select UE profiles comprise:
a basic profile of individual UE capabilities common to all UE profiles.

4. The apparatus of claim 1, wherein the one or more processors are further configured to:
identify, at the UE, a role of the UE with the active UE profile based on the role identified by the UE.

5. The apparatus of claim 1, wherein the one or more processors are further configured to:
initiate, at the UE, one or more select UE profiles from the list of pre-determined UE profiles.

6. The apparatus of claim 1, wherein the one or more processors are further configured to:
initiate, at the UE, which of the one or more select UE profiles is the active UE profile at the UE.

7. The apparatus of claim 1, wherein the UE profile message further comprises:
a select profile that comprises a pre-determined subset of individual UE capability features grouped together to define a UE role in the NW to enable the UE to dynamically switch roles.

8. The apparatus of claim 1, wherein the active UE profile reduces the active capabilities supported by the UE.

9. The apparatus of claim 1, wherein the active UE profile is based on a change in user configuration (UC) of the UE.

10. The apparatus of claim 1, wherein at least one of the one or more select UE profiles is inactive while at least one of the one or more select UE profiles is active.

11. The apparatus of claim 1, wherein the one or more processors are further configured to:
enable and disable, at the UE, the one or more select UE profiles.

12. The apparatus of claim 1, wherein at least one of the one or more select UE profiles comprises:
semi-static parameters that are the same; and
dynamic parameters that are changed.

13. The apparatus of claim 1, wherein the one or more processors are further configured to:
generate, at the UE, a UE profile default configuration request for transmission to the NW via the base station;
wherein the UE profile default configuration request comprises a set of semi-static default configurations in addition to a pre-determined semi-static parameter.

14. The apparatus of claim 13, wherein the one or more processors are further configured to:
receive, at the UE, one or more UE profile default configuration profiles from the NW via the base station;
wherein the one or more UE profile default configuration profiles comprise a set of semi-static default configurations in addition to pre-determined semi-static parameters.

15. The apparatus of claim 1, wherein the one or more processors are further configured to:
receive, at the UE, a handover (HO) command from a source base station;
wherein the HO command is based on an exchange between the source base station and a target base station regarding an active UE profile and default configuration information.

16. The apparatus of claim 1, wherein the one or more processors are further configured to:
generate, at the UE, a UE profile change message for transmission to the NW via the base station;
wherein the UE profile change message comprises a select UE profile that comprises a pre-determined subset of individual UE capability features grouped together to define a UE role in the NW to enable the UE to dynamically switch roles.

17. The apparatus of claim 16, wherein the one or more processors are further configured to:
receive, at the UE, a reconfiguration message from the NW via the base station comprising a new UE configuration based on the select profile of the UE profile change message.

18. The apparatus of claim 17, wherein the one or more processors are further configured to:
change the UE role in the NW based on the reconfiguration message.

19. The apparatus of claim 1, wherein the one or more processors are further configured to:
receive, at the UE, a UE profile change criteria request message from the NW via the base station;
wherein the UE profile change criteria request message comprises a criteria request based on one or more of cell quality, location, time or activity; and
generate, at the UE, a UE profile change criteria confirmation message for transmission to the NW via the base station.

20. The apparatus of claim 1, wherein the one or more processors are further configured to:
generate, at the UE, a UE profile change criteria indication message for transmission to the NW via the base station;
wherein the UE profile change criteria indication message comprises a criteria request based on one or more of cell quality, location, time or activity; and
receive, at the UE, a UE profile change criteria response message from the NW via the base station.
